(19) United States
(12) Patent Application Publication
(10) Pub. No.: US 2004/0248741 A1
(43) Pub. Date: Dec. 9, 2004

(54) Use of water-soluble or water-dispersible graft polymers comprising polyether blocks as coating materials, matrix formers and/or packaging material for agrochemicals

(76) Inventors: Michael Gotsche, Mannheim (DE); Marcos Gomez, Heidelberg (DE); Tanja Schneider, Bensheim (DE); Helmut Meffert, Mannheim (DE); Karl-Heinrich Schneider, Kleinkarlbach (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/480,541

(22) PCT Filed: May 31, 2002
(86) PCT No.: PCT/EP02/06045

(30) Foreign Application Priority Data
Jun. 13, 2001 (DE) 101 28 531.0

(51) Int. Cl. A01N 25/10

(52) U.S. Cl. 504/361

(57) ABSTRACT

Water-soluble or water-dispersible, film-forming graft copolymers obtainable by free-radical polymerization of

a) vinyl esters of aliphatic C₁-C₂₄-carboxylic acids in the presence of

b) polyethers with an average molecular weight (number average) of at least 300 of the formula I

R¹—((R²—O)ᵤ(R³—O)ᵥ(R⁴—O)_{w}[A (R^{5—O)}ₓ(R⁶—O)_{y}(R⁷—O)_{z}]ₛR⁸)ₙ I

in which the variables independently of one another have the following meanings:

R^{l} is hydroxyl, amino, C₁-C₂₄-alkoxy, R⁹—COO—, R⁹—NH—COO—, polyalcohol residue;

R² to R⁷ are —(CH₂)₂—, —(CH₂)₃—, —(CH₂)₄—, —CH₂—CH(CH₃)—, —CH₂—CH(CH₂—CH₃)—, —CH₂—CHOR¹⁰—CH₂—;

R⁸ is hydrogen, amino-C₁-C₆-alkyl, C₁-C₂₄-alkyl, R⁹—CO—, R⁹—NH—CO—;

R⁹ is C₁-C₂₄-alkyl;

R¹⁰ is hydrogen, C₁-C₂₄-alkyl, R⁹—CO—;

A is —CO—O—, —CO—B—CO—0—, —CO—NH—B—NH—CO—0—;

B is —(CH₂)ₜ—, unsubstituted or substituted arylene;

n is 1 or, if R¹ is a polyalcohol residue, 1 to 8;

s is 0 to 500; t is 1 to 12; u is 1 to 5000; v is 0 to 5000;

w is 0 to 5000; x is 1 to 5000; y is 0 to 5000; z is 0 to 5000

are used as coating materials, matrix formers and/or packaging materials for agrochemicals.

The invention relates to the use of water-soluble or water-dispersible, film-forming graft polymers obtainable by free-radical polymerization of

(a) vinyl esters of aliphatic C₁-C2₄-carboxylic acids in the presence of

(b) polyethers with an average molecular weight (number average) of at least 300 of the formula I

R¹—((R²—O)ᵤ(R³—O)ᵥ(R⁴—O—)_{w}[A)R⁵O)ₓ(R⁶—O)_{y}(R⁷—O)_{z}]ₛR⁸)ₙ I

in which the variables independently of one another have the following meanings:

R¹ is hydroxyl, amino, C₁-C₂₄-alkoxy, R⁹—COO—, R⁹—NH—COO—, polyalcohol residue;

R² to R⁷ are —(CH₂)₂—, —(CH₂)₃—, —(CH₂)₄—, —CH₂—CH(CH₃)—, —CH₂—CH(CH₂—CH₃)—, —CH₂—CHOR¹⁰—CH₂—;

R⁸ is hydrogen, amino-C₁-C₆-alkyl, C₁-C₂₄-alkyl, R⁹—CO—, R⁹—NH—CO—;

R⁹ is C₁-C₂₄-alkyl;

R¹⁰ is hydrogen, C₁-C₂₄-alkyl, R⁹—CO—;

A is —CO—O—, —CO—B—CO—O—, —CO—NH—B—NH—CO—O—;

B is —(CH₂)ₜ—, unsubstituted or substituted arylene;

n is 1 or, if R¹ is a polyalcohol residue, 1 to 8;

s is 0 to 500;

t is 1 to 12;

u is 1 to 5000;

v is 0 to 5000;

w is 0 to 5000;

x is 1 to 5000;

y is 0 to 5000;

z is 0 to 5000,

as coating materials, matrix formers and/or packaging materials for agrochemicals, and to agrochemical preparations comprising these graft polymers.

To avoid skin contact with agrochemicals, it is known to package these substances portionwise in water-soluble film bags which disintegrate upon contact with water and release the agrochemicals which they contain. Water-soluble films made of polyvinyl alcohol obtained by 85 to 90% hydrolysis of polyvinyl acetate and which are suitable for this purpose are describe in U.S. Pat. No. 5,328,025 and WO-A-97/37093.

However, films made of polyvinyl alcohol have the disadvantage that, in a moist environment, they stick to each other. This is the case especially when two or more bags are lying one on top of the other. Also, polyvinyl alcohol only dissolves slowly in water, and not always completely. In addition, polyvinyl alcohol tends toward embrittlement if the ambient moisture content is low, and shows a dramatic decrease in flexibility. This is why it is common to add plasticizers to polyvinyl alcohol in the form of low-molecular-weight compounds. These plasticizers frequently pass from the wrapper into the contents and lead to changes in the active ingredients. During this process, the wrapper becomes depleted in plasticizers and becomes brittle and unstable in the course of storage.

Polyvinyl alcohol is also employed for directly coating agrochemicals with a protective film. Thus, JP-A-228 274/1999 describes applying a polyvinyl alcohol film to fertilizers which have already been coated with sulfur. However, the abovementioned disadvantages when polyvinyl alcohol is used as packaging material are also found here.

Moreover, DE-A-197 09 532 discloses coating agrochemical preparations with polymers comprising mixtures of polyvinyl acetate and N-vinylpyrrolidone. EP-A-381 181 describes an active ingredient formulation based on coated active-ingredient-comprising cores which comprise polyvinyl alcohol with a residual acetate content of 6 to 18 mol % as swelling agent. Agrochemicals are only mentioned as active ingredients

WO-A-91/03149 discloses a seed formulation based on a peat matrix comprising polyvinyl alcohol as binder together with a nonionic surfactant.

The disadvantageous properties of polyvinyl alcohol which have already been mentioned also have a negative impact on these preparations.

WO-A-92/15197 and 93/25074 describe water-dispersible granules for crop protection which comprise the active ingredient together with ethoxylated alkylphenols, ethylene oxide/propylene oxide block copolymers or polyethylene glycols as heat-activatable binders and various adjuvants, such as anionic surfactants, disintegrants, and fillers.

WO-A-00/18375 and DE-A-100 50 958, unpublished at the priority date of the present invention, describe the use of graft polymers of vinyl esters on polyethers such as polyalkylene glycols as coating materials, binders and/or film-forming adjuvant in pharmaceutical formulations or as coating and packaging materials for detergents and cleaners.

Such graft polymers are also known from the following publications:

DE-B-1 077 430 describes a process for the preparation of graft polymers of vinyl esters in which polyalkylene glycols and/or derivatives thereof are dissolved in at least one vinyl ester in the presence or absence of further solvents, and the resulting solution is subjected to free-radical polymerization. The graft polymers are used in the textile industry, as tackifiers and stickers, in the leather industry, as a base material in the coatings industry, in the photographic industry, and as hair care materials.

DE-B-1 081 229 discloses a process for the preparation of water-soluble modified polyvinyl alcohols consisting of at least 50% by weight of polyvinyl alcohol units. They are prepared by subjecting graft polymers of at least one vinyl ester on polyalkylene glycols to full or partial hydrolysis in the acidic or alkaline pH range. The polyalkylene glycol fraction in the graft polymer is 0.1 to 50% by weight. The modified polyvinyl alcohols are colorless or sparingly colored loose powders which dissolve readily in water. They are said to be suitable for the preparation of water-soluble packaging films, as sizing and finishing agents, and for cosmetic articles.

DE-B-1 094 457 discloses modified polyvinyl alcohols which are composed of a graft polymer of at least one vinyl ester and, if desired, other monomers which are copolymerizable therewith on polyalkylene glycols, the graft polymer having been hydrolyzed to an extent such that the resulting modified polyvinyl alcohol is soluble even in cold water, but comprises less than 50% by weight of polyvinyl alcohol units. The modified polymers are said to be suitable as protective colloids for the preparation of polymer dispersions and as starting materials for the production of foams, as a material for the preparation of soft, readily water-soluble, transparent films, as sizing and finishing agents, and for cosmetic articles.

It is an object of the present invention to overcome the abovementioned shortcomings and to provide agrochemical preparations with advantageous use properties in an economic fashion. In particular, the preparations should be dust-free, they should be easy to handle and to dose, they should not exhibit a tendency to form sticky aggregates, and they should be finely dispersible.

We have found that this object is achieved by using water-soluble or water-dispersible, film-forming graft polymers obtainable by free-radical polymerization of

(a) vinyl esters of aliphatic C₁-C₂₄-carboxylic acids in the presence of

(b) polyethers with an average molecular weight (number average) of at least 300 of the formula I

R¹—((R²—O)ᵤ(R³—O)ᵥ(R⁴—O)_{w}[A(R⁵—O)ₓ(R⁶—O)_{y}(R⁷—O)_{z}]ₛR⁸)ₙ I

in which the variables independently of one another have the following meanings:

R¹ is hydroxyl, amino, C₁-C₂₄-alkoxy, R⁹—COO—, R⁹—NH—COO—, polyalcohol residue;

R² to R⁷ are —(CH₂)₂—, —(CH₂)₃—, —(CH₂)₄—, —CH₂—CH(CH₃)—, —CH₂—CH(CH₂—CH₃)—, —CH₂—CHOR¹⁰—CH₂—;

R⁸ is hydrogen, amino-C₁-C₆-alkyl, C₁-C₂₄-alkyl, R⁹—CO—, R⁹—NH—CO—;

R⁹ is C₁-C₂₄-alkyl;

R¹⁰ is hydrogen, C₁-C₂₄-alkyl, R⁹—CO—;

A is —CO—O—, —CO—B—CO—O—, —CO—NH—B—NH—CO—O—;

B is —(CH₂)ₜ—, unsubstituted or substituted arylene;

n is 1 or, if R¹ is a polyalcohol residue, 1 to 8;

s is 0 to 500;

t is 1 to 12;

u is 1 to 5000;

v is 0 to 5000;

w is 0 to 5000;

x is 1 to 5000;

y is 0 to 5000;

z is 0 to 5000,

as coating materials, matrix formers and/or packaging material for agrochemicals.

Graft polymers which are preferably used can be seen from the dependent claims.

We have furthermore found agrochemical preparations in finely divided form exhibiting a formulation of one or more agrochemical active ingredients as the substrate material with a coating comprising one of these graft polymers.

Moreover, we have found agrochemical preparations in granule form exhibiting one or more agrochemical active ingredients in a matrix comprising one of these graft polymers as matrix former.

Finally, we have found agrochemical preparations in the form of single portions for dosage purposes, where an agrochemical active ingredient formulation is packaged portionwise in films comprising these graft polymers.

The graft polymers used in accordance with the invention are disclosed in WO-A-00/18375 and the earlier German patent application 100 50 958.4.

The graft base (b) generally comprises polyethers of the formula I selected from the group consisting of polyalkylene oxides based on ethylene oxide, propylene oxide and butylene oxides, polytetrahydrofuran, and polyglycerol. Depending on the nature of the monomer units, polymers with the following structural units result:

—(CH₂)₂—O—, —(CH₂)₃—O—, —(CH₂)₄—O—, —CH₂—CH(CH₃)—O—, —CH₂—CH(CH₂—CH₃)—O—, —CH₂—CHOR¹⁰—CH₂—O—

They may take the form of homopolymers or else copolymers, it being possible for the copolymers to be distributed randomly or to be present as what are known as block polymers.

The terminal primary hydroxyl groups of the polyethers prepared on the basis of alkylene oxide or glycerol, and the secondary OH groups of polyglycerol, can either be in free form or else unilaterally or bilaterally etherified with C₁-C₂₄-alcohols or esterified with C₁-C₂₄-carboxylic acids. Alternatively, they may have been substituted for primary amino groups by reductive amination with hydrogen/ammonia mixtures under pressure, or may been converted into aminopropyl end groups by cyanoethylation with acrylonitrile and hydrogenation.

Alkyl radicals R¹ and R⁸ to R¹⁰ can be branched or unbranched C₁-C₂₄-alkyl radicals, with C₁-C₁₂-alkyl radicals being preferred and C₁-C₆-alkyl radicals being especially preferred. Examples which may be mentioned are methyl, ethyl, n-propyl, 1-methylethyl, n-butyl, 1-methylpropyl, 2-methylpropyl, 1,1-dimethylethyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 2-ethylhexyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl and n-eicosyl.

The average molecular weight (number average) of the polyethers (b) amounts to 300 and is, as a rule, ≦500 000. It amounts to preferably 500 to 100 000, especially preferably 500 to 50 000 and very especially preferably 1000 to 10 000.

It is advantageous to use homopolymers of ethylene oxide or copolymers having an ethylene oxide fraction of 40 to 99% by weight. For the ethylene oxide polymers to be employed by preference, the fraction of copolymerized ethylene oxide is therefore 40 to 100 mol %. Suitable comonomers for these copolymers include propylene oxide, butylene oxide and/or isobutylene oxide. Examples of suitable copolymers are those of ethylene oxide and propylene oxide, of ethylene oxide and butylene oxide and/or isobutylene oxide, and of ethylene oxide, propylene oxide and butylene oxide or isobutylene oxide. The copolymers preferably comprise 40 to 99 mol % of ethylene oxide and 1 to 60 mol % of propylene oxide or 1 to 30 mol % of butylene oxide, or 1 to 60 mol % of propylene oxide and (iso)butylene oxide.

In addition to straight-chain homo- or copolymers, branched homo- or copolymers may also be used as the graft base.

Branched polymers can be prepared by subjecting ethylene oxide and, if desired, propylene oxide and/or butylene oxides or polyglycerol to an addition reaction with, for example, low-molecular-weight polyalcohols (radicals R¹ in the formula I), for example pentaerythritol, glycerol and sugars or sugar alcohols such as sucrose, d-sorbitol and D-mannitol, disaccharides.

This may give rise to polymers in which at least one, preferably one to eight, particularly preferably one to five, of the hydroxyl groups present in the polyalcohol molecules may be bonded in the form of an ether bond to the following polyether radical p, in accordance with the formula I

(R²—O)ᵤ(R³—O)ᵥ(R⁴—O)_{w}[A(R⁵—O)ₓ(R⁶—O)_{y}(R⁷—O)_{z}]ₛR⁸

However, it is also possible to use, as the graft base, polyesters of polyalkylene oxides and aliphatic C₁-C₁₂—, preferably C₁-C₆-dicarboxylic acids or aromatic dicarboxylic acids, for example oxalic acid, succinic acid, adipic acid or terephthalic acid, with average molecular weights of 1500 to 25 000, as described in WO-A-95/21880.

It is furthermore possible to use, as the graft base, polycarbonates of polyalkylene oxides, prepared by phosgenation, or else polyurethanes of polyalkylene oxides and aliphatic C₁-C₁₂—, preferably C₁-C₆—, diisocyanates or aromatic diisocyanates, for example hexamethylenediisocyanate or phenylenediisocyanate.

These polyesters, polycarbonates or polyurethanes may comprise up to 500, preferably up to 100, polyalkylene oxide units, it being possible for the polyalkylene oxide units to be composed of both homopolymers and copolymers of various alkylene oxides.

Materials which are employed as graft component (a) are vinyl esters of aliphatic, saturated or unsaturated C₁-C₂₄-carboxylic acids, preferably C₁-C₁₂-carboxylic acids and especially preferably C₁-C₆-carboxylic acids. Individual examples which may be mentioned are: formic acid, acetic acid, propionic acid, butyric acid, valeric acid, isovaleric acid, caproic acid, caprylic acid, capric acid, undecylenic acid, lauric acid, myristic acid, palmitic acid, palmitoleic acid, stearic acid, oleic acid, arachidic acid, behenic acid, lignoceric acid, cerotic acid and melissic acid, with acetic acid being especially preferred.

Naturally, mixtures of the respective vinyl esters (a) may also be graft-polymerized.

In addition, the vinyl esters (a) may also be employed as a mixture with one or more comonomers (c). The comonomers (c) can be hydrophobic or hydrophilic, the compounds conventionally used as crosslinker also being suitable. If comonomers (c) are employed, they generally amount to 0.1 to 30% by weight, preferably 1 to 20% by weight, in the mixture.

Suitable hydrophobic comonomers (c) can be selected from among the following groups; naturally, mixtures of the monomers can also be employed:

(c₁) C₁-C₂₄-alkylesters of monoethylenically unsaturated C₃-C₈-carboxylic acids;

(c₂) C₁-C₂₄-hydroxyalkyl esters of monoethylenically unsaturated C₃-C₈-carboxylic acids;

(c₃) C₁-C₂₄-alkyl vinyl ethers;

(c₄) N-vinyl lactams;

(c₅) monoethylenically unsaturated C₃-C₈-carboxylic acids.

Examples of suitable monoethylenically unsaturated C₃-C₈-carboxylic acids are acrylic acid, methacrylic acid, maleic acid, fumaric acid, itaconic acid-and aconitic acid.

As examples of the alkyl radicals, the abovementioned C₁-C₂₄-alkyl radicals and their hydroxylation products may be referred to. Preferred are branched or unbranched C₁-C₄-alkyl radicals, in particular methyl, ethyl, n-propyl, 1-methylethyl, n-butyl, 1-methylpropyl, 2-methylpropyl and 1,1-dimethylethyl and their hydroxylation products.

Especially preferred are monomers of groups (c₁) to (c₃). Very especially preferred are methyl (meth)acrylate, ethyl (meth)acrylate, hydroxymethyl (meth)acrylate, 2-hydroxyethyl (meth)acrylate, methyl vinyl ether and ethyl vinyl ether.

Suitable hydrophilic comonomers (c) are, for example, monoethylenically unsaturated C₃-C₈-carboxylic acids such as acrylic acid, methacrylic acid, maleic acid, fumaric acid, itaconic acid and aconitic acid, and also N-vinyllactams such as N-vinylpyrrolidone, N-vinylimidazole and N-vinylcaprolactam.

Preferred hydrophilic comonomers (c) are acrylic acid, methacrylic acid and N-vinylpyrrolidone.

Suitable comonomers (c) which are usually employed as crosslinkers are compounds comprising at least two ethylenically unsaturated unconjugated double bonds in the molecule. Preferred examples are alkylenebisacrylamides, such as methylenebisacrylamide and N,N′-acryloylethylenediamine, vinylalkyleneureas, such as N,N′-divinylethyleneurea and N,N′-divinylpropyleneurea, ethylidene-bis-3-(N-vinylpyrrolidone), N,N′-divinylimidazolyl(2,2′)butane, 1,1′-bis-(3,3′-vinylbenzimidazolid-2-one)1,4-butane, alkylene glycol di(meth)acrylates, such as ethylene glycol di(meth)acrylate, tetraethylene glycol di(meth)acrylate and diethylene glycol di(meth)acrylate, aromatic divinyl compounds such as divinylbenzene and divinyltoluene, and also vinyl acrylate, allyl (meth)acrylate, divinyldioxane, pentaerythritol triallyl ether and triallylamines.

Depending on the degree of grafting, the polymers used in accordance with the invention can be either pure graft polymers or else mixtures of graft polymers with ungrafted polyethers (b) and homo- or copolymers of the vinyl esters (a) and, if desired, further monomers (c).

Preference is given to the use of polymers obtainable by polymerization of

(a) at least one vinyl ester of aliphatic C₁-C₂₄-carboxylic acids in the presence of

(b) polyethers with an average molecular weight (number average) of 500 to 100 000 of the formula Ia

R ¹—((R²—O)ᵤ(R³—O)ᵥ(R⁴—O)_{w}R⁸)ₙ Ia

in which the variables independently of one another have the following meanings:

R¹ is hydroxyl, amino, C₁-C₂₄-alkoxy, R⁹—COO—, R⁹—NH—COO—, polyalcohol residue;

R² to R⁴ are —(CH₂)₂—, —(CH₂)₃—, —(CH₂)₄—, —CH₂—CH(CH₃)—, —CH₂—CH(CH₂—CH₃)—, —CH₂—CHOR¹⁰—CH₂—;

R⁸ is hydrogen, amino-C₁-C₆-alkyl, C₁-C₂₄-alkyl, R⁹—CO—, R⁹—NH—CO—;

R⁹ is C₁-C₂₄-alkyl;

R¹⁰ is hydrogen, C₁-C₂4-alkyl, R⁹—CO—;

n is 1 or, if R¹ is a polyalcohol residue, 1 to 8;

u is 1 to 5000;

v is 0 to 5000;

w is 0 to 5000.

Special preference is given to the use of polymers obtainable by polymerization of

(a) at least one vinyl ester of aliphatic C₁-C₁₂-carboxylic acids in the presence of

(b) polyethers with an average molecular weight (number average) of 500 to 50 000 of the formula Ia in which the variables independently of one another have the following meanings:

R¹ is hydroxyl, C₁-C₁₂-alkoxy, polyalcohol residue;

R² to R⁴ are —(CH₂)₂—, —(CH₂)₃—, —(CH₂)₄—, —CH₂—CH(CH₃)—, —CH₂—CH(CH₂—CH₃)—, —CH₂—CHOR¹⁰—CH₂—;

R⁸ and R¹⁰ are hydrogen, C₁-C₁₂-alkyl;

n is 1 or, if R¹ is a polyalcohol residue, 1 to 5;

u is 2 to 2000;

v is 0 to 2000;

w is 0 to 2000.

Very particular preference is given to the use of polymers obtainable by polymerization of

(a) at least one vinyl ester of aliphatic C₁-C₆-carboxylic acids, in particular vinyl acetate, in the presence of

(b) polyethers with an average molecular weight (number average) of 1000 to 10 000 of the formula Ia in which the variables independently of one another have the following meanings:

R¹ is hydroxyl, C₁-C₆-alkoxy, preferably hydroxyl;

R² to R⁴ are —(CH₂)₂—, —(CH₂)₃—, —(CH₂)₄—, —CH₂—CH(CH₃)—, —CH₂—CH(CH₂—CH₃)—, —CH₂—CHOR¹⁰—CH₂—;

R⁸ is hydrogen, C₁-C₆-alkyl, preferably hydrogen;

R¹⁰ is hydrogen, C₁-C₆-alkyl;

n is 1;

u is 5 to 500;

v is 0 to 500, preferably 0;

w is 0 to 500, preferably 0.

Graft polymers whose graft base is a polyglycerol are obtainable by polymerization of

(a) at least one vinyl ester of aliphatic C₁-C₂₄-carboxylic acids in the presence of

(b) polyglycerols of the formula Ib

R¹—((CH₂—CHOR¹⁰—CH₂—O)ᵤR⁸)ₙ Ib

in which the variables independently of one another have the following meanings:

R¹ is hydroxyl, C₁-C₂₄-alkoxy, R⁹—COO—, polyalcohol residue;

R⁸ and R¹⁰ are hydrogen, C₁-C₂₄-alkyl, R⁹—CO—;

R⁹ is C₁-C₂₄-alkyl;

n is 1 or, if R¹ is a polyalcohol residue, 1 to 8;

u is 1 to 2000.

Preferred graft polymers based on polyglycerols are obtainable by polymerization of

(a) at least one vinyl ester of aliphatic C₁-C₆-carboxylic acids in the presence of

(b) polyglycerols of the formula Ib, in which the variables independently of one another have the following meanings:

R¹ is hydroxyl, C₁-C₆-alkoxy;

R⁸ and R¹⁰ are hydrogen, C₁-C₆-alkyl;

n is 1;

u is 1 to 100.

In addition to linear polyglycerols, branched and/or cyclic polyglycerols may also be used as the graft base.

The K values of the graft polymers are usually 10 to 200, preferably 15 to 150, especially preferably 15 to 100 and very especially preferably 20 to 80 (determined by the method of H. Fikentscher, Cellulose-Chemie, Vol. 13, pp. 58 to 64 and 71 to 74 (1932) in N-methylpyrrolidone at 25° C. and polymer concentrations which, depending on the K-value range, are from 0.1% by weight to 5% by weight). The K value desired in each case can be set in the manner known per se through the composition of the starting materials.

To prepare the graft polymers used in accordance with the invention, the vinyl esters (a) and, if desired, the comonomers (c) can be polymerized in the presence of the polyethers (b) as graft base, both with the aid of free-radical-forming initiators and by exposure to high-energy radiation, which is also intended to include exposure to high-energy electrons.

The polymerization can be carried out, for example, as a solution polymerization, bulk polymerization, emulsion polymerization, inverted emulsion polymerization, suspension polymerization, inverted suspension polymerization or precipitation polymerization.

In the case of the bulk polymerization, which is preferably carried out, one possible procedure is to dissolve the polyether (b), in particular the polyalkylene oxide (b), in at least one vinyl ester (a) and, if desired, one or more comonomers (c) and to polymerize the mixture after addition of a polymerization initiator. The graft polymerization may also be carried out semicontinuously, by first introducing part, for example, 10% by weight, of this mixture and heating it to polymerization temperature and, following the onset of the polymerization, adding the remainder of the polymerization mixture in accordance with the progress of the polymerization reaction. However, it is also possible to charge a reactor with the polyether (b) and to heat the latter to polymerization temperature and to add vinyl ester (a) and, if desired, comonomer (c) (either separately or as a mixture) and polymerization initiator either all at once, in portions or, preferably continuously, and to polymerize the batch.

The weight ratio of the polyether (b) used as graft base to the vinyl esters (a), or mixture of the vinyl esters (a) and the comonomers (c), is, as a rule, 1:0.5 to 1:50, preferably 1:1.5 to 1:35 and especially preferably 1:2 to 1:30.

Suitable polymerization initiators are, especially, organic peroxides such as diacetyl peroxide, dibenzoyl peroxide, succinyl peroxide, di-tert-butyl peroxide, tert-butyl perbenzoate, tert-butyl perpivalate, tert-butyl permaleate, cumene hydroperoxide, diisopropyl peroxidicarbonate, bis-(o-toluyl)peroxide, didecanoyl peroxide, dioctanoyl peroxide, dilauroyl peroxide, tert-butyl perisobutyrate, tert-butyl peracetate, di-tert-amyl peroxide, tert-butyl hydroperoxide, and mixtures of these, and also redox initiators and azo initiators.

Between 0.01 and 10% by weight, preferably between 0.3 and 5% by weight, of initiator are usually employed based on the vinyl ester (a) or the mixture of vinyl ester (a) and comonomer (c).

As a rule, the polymerization temperature is 40 to 200° C., preferably 50 to 140° C., and especially preferably 60 to 110° C.

The polymerization is normally carried out under atmospheric pressure, but may also proceed under subatmospheric or superatmospheric pressure, for example at 1 to 5 bar.

If desired, the above-described graft polymerization may also be carried out in a solvent. Examples of suitable organic solvents are, for example, aliphatic and cycloaliphatic monohydric alcohols such as methanol, ethanol, n-propanol, isopropanol, n-butanol, sec-butanol, tert-butanol, n-hexanol and cyclohexanol, polyhydric alcohols, for example glycols such as ethylene glycol, propylene glycol and butylene glycol, and glycerol, alkyl ethers of polyhydric alcohols, for example the methyl and ethyl ethers of the abovementioned glycols, and also ether alcohols such as diethylene glycol and triethylene glycol, and cyclic ethers such as dioxane.

The graft polymerization may also be carried out in water as the solvent. If it is intended that water-insoluble products which are formed during the polymerization are to be obtained directly in dissolved form, water-miscible organic solvents may be added during the polymerization, for example monohydric alcohols having 1 to 3 carbon atoms, acetone or dimethylformamide.

When carrying out the graft polymerization in water, however, a procedure may also be followed in which the water-insoluble graft polymers are converted into a fine dispersion by adding customary emulsifiers or protective colloids (for example polyvinyl alcohol). Examples of suitable emulsifiers are ionic or nonionic surfactants whose HLB value is in the range from 3 to 13. For the definition of the HLB value, reference may be made to the publication by W. C. Griffin, J. Soc. Cosmetic Chem., Vol. 5, 249 (1954). If surfactants are applied during the graft polymerization, they generally amount to 0.1 to 5% by weight, based on the graft polymer.

Usually, 5 to 200% by weight, preferably 10 to 100% by weight, of organic solvent, water or mixture of water and organic solvent are used, based on the graft polymer.

In order to increase the hydrophilicity of the graft polymers used in accordance with the invention, all or some of the ester groups can be hydrolyzed after polymerization. Hydrolysis is effected in a manner known per se by adding a base, preferably an alcoholic alkali metal hydroxide solution, in particular a methanolic sodium hydroxide or potassium hydroxide solution, at temperatures ranging from 10 to 70° C., preferably 15 to 30° C.

The degree of hydrolysis depends on the amount of base employed, on the hydrolysis temperature, and on the hydrolysis time, and may therefore be in the range of from 0 to 100 mol %. The degree of hydrolysis is, in particular, 20 to 100 mol %, preferably 40 to 100 mol %, especially preferably 65 to 100 mol %, and very especially preferably 80 to 100 mol %.

The solids content of the resulting aqueous polymer dispersions or solutions obtained after exchanging the alcohol for water, for example by steam distillation, generally amounts to 10 to 70% by weight, preferably 15 to 65% by weight, especially preferably 20 to 60% by weight.

Depending on the degree of hydrolysis and the concentration, aqueous dispersions or solutions of the graft polymers used in accordance with the invention are usually obtained, with a viscosity of less than 1000 mPas. In the case of a polymer concentration of 20% by weight, the viscosity is, in particular, 5 to 400 mPas, especially 10 to 250 mPas.

The graft polymer dispersions or solutions may be converted into powder form with the aid of various drying methods, such as spray drying, fluidized spray drying, roll drying, or freeze drying.

Owing to the low viscosity of the solutions or dispersions, spray drying is preferred. An aqueous dispersion or solution may be prepared again by introducing the resulting dry graft polymer powder into water. Pulverulent graft polymers have better storage properties, greater ease of transport and a lesser tendency toward microbial infection compared with dispersions and solutions, in particular aqueous dispersions and solutions.

The graft polymers are outstandingly suitable for preparing agrochemical preparations, being employed for coating agrochemical active ingredient formulations, as matrix formers for agrochemical active ingredients or, in the form of films, as packaging material for agrochemical active ingredient formulations. They not only make it possible to encapsule the active ingredients in such a way that no odor escapes, but they simultaneously act advantageously as dispersant when applying the active ingredients, which are liberated in contact with water. The preparations in accordance with the invention are dust-free, easy to handle and to dose, contact of the active ingredients with the user's skin successfully being avoided.

To coat agrochemical active ingredient formulations, the graft polymers, in pure form or else together with customary adjuvants, can be applied to a substrate comprising active ingredient, for example to finely divided agrochemical formulations, such as agrochemical-comprising tablets, granules, for example water-dispersible granules, pellets, flakes, extrudates, spheres or powders, for example powders which can be dissolved in or diluted with water, or else to seed. Customary adjuvants are, for example, color pigments for coloring, white pigments, such as titanium dioxide, for increasing the hiding power, talc and silicon dioxide as non-stick agents, polyethylene glycols, glycerol, propylene glycol, triacetine, triethyl citrate as plasticizer and surfactants, such as-sodium lauryl sulfate, to improve the wetting behavior.

The coating comprising the graft polymer to be used in accordance with the invention can be applied to the substrate by customary methods, for example coating in a fluidized bed or in a horizontal drum coater, by the dip-coating process and the pan-coating process.

The coating comprising the graft polymer has a thickness of, as a rule, 1 to 1000 μm, preferably 5 to 500 μm, especially preferably 10 to 100 μm.

The graft polymers to be used in accordance with the invention can be combined with other film formers or polymers. Suitable weight ratios for this purpose are usually in the range of 1:9 to 9:1.

Examples of film formers or polymers which are suitable for this purpose are: polyvinylpyrrolidone; polyvinylpyrrolidone copolymers; water-soluble cellulose derivatives such as hydroxypropylcellulose, hydroxypropylmethylcellulose, methylcellulose and hydroxyethylcellulose; acrylate and methacrylate copolymers; polyvinyl alcohols; polyethylene glycols and polyethylene oxide/polypropylene oxide block polymers. Melts from such polymer mixtures can be processed to give, for example, granules, powders or films which can be employed directly for packaging agrochemicals.

When employed as matrix formers for agrochemical preparations in granule form, the graft polymers to be used in accordance with the invention are preferably combined with polymeric binders and mineral fillers.

Examples of polymeric binders which are suitable for this purpose are: polyolefins, such as polyethylene, polypropylene, polybutylene and polyisobutylene.; vinylpolymers such as polyvinyl chloride, polyvinyl acetate and polystyrene; polyacrylonitrile; poly(meth)acrylates, polyacetals, such as polyoxymethylene; polyesters, such as polyhydroxybutyric acid, polyhydroxyvaleric acid, polyalkylene terephthalates and polyalkylene adipate terephthalates, for example polybutylene adipate terephthalates; polyester amides; polyether amides; polyamides; polyimides; polyethers; polyether ketones; polyurethanes, polycarbonates; copolymers of ethylene/vinyl acetate, ethylene/(meth)acrylates, styrene/acrylonitrile, styrene/butadiene, styrene/butadiene/acrylonitrile and olefin/maleic anhydride. Preferred in this context are polyolefins, such as polyethylene and polypropylene, and polyesters. Especially preferred are biodegradable polybutylene adipate terephthalates, as they are described in DE-A-44 40 858 (Ecoflex®, BASF).

Suitable mineral fillers are substances which, owing to their density, improve or make possible the sedimentation of the granules in aqueous medium, which can be incorporated into the polymers in large quantities, which are not unduly hard, i.e. can be processed readily in the extruder, are chemically indifferent, increase the heat resistance of the preparation, are thermally stable themselves, improve the granulation properties of the melt and make possible the release of the active ingredient, are environmentally friendly and, additionally, as inexpensive as possible.

Examples of suitable mineral fillers are: oxides, hydroxides, silicates, carbonates and sulfates of calcium, magnesium, aluminum and titanium, and their mixtures. Substances which may be mentioned particularly are, for example, lime, chalk, gypsum, bentonite, kaolin, wollastonite, talc, phlogopite and clay minerals. Lime, gypsum and talc are preferred.

The granular agrochemical preparations according to the invention generally comprise 1 to 70% by weight, preferably 5 to 60% by weight and especially preferably 10 to 50% by weight of the graft polymers according to the invention, based on the preparation.

The content of polymeric binder preparations usually amounts to 0 to 95% by weight, preferably 10 to 70% by weight and especially preferably 20 to 60% by weight.

The mineral fillers are usually present in amounts of 10 to 80% by weight, preferably 10 to 70% by weight and especially preferably 10 to 60% by weight, also based on the total preparation.

Furthermore, the granular preparations according to the invention may additionally comprise surface-active additives, which should, as a rule, amount to not more than 20% by weight, preferably to not more than 10% by weight and especially preferably to not more than 5% by weight of the preparation.

In general, the content of agrochemical active ingredient amounts to 0.1 to 80% by weight, preferably 0.5 to 40% by weight and especially preferably 1 to 20% by weight.

The release of the agrochemical active ingredient can be controlled in a targeted fashion by varying the composition of the preparations according to the invention. The more graft polymer to be used in accordance with the invention and/or the more mineral filler present, the more rapid the release of the active ingredient.

To prepare the granular preparations according to the invention, it is possible either to melt all components directly with each other in the form of a physical mixture or to mix them with the preexisting polymer melt. In general, it is customary to meter a freely-charged physical mixture of active ingredient, filler, graft polymer, binder and, if desired, additive jointly, for example via a differential weigh feeder, into a kneader or an extruder, preferably a single- or twin-screw extruder where it is melted at approximately 50 to 200° C. Shaping of the melt which exits may be effected by extrusion granulation of the fully or partially cooled extrudates, by hot cutting of the melt at the extruder head using a cut-off unit with rotating knives, by underwater granulation directly at the exit point of the melt from the nozzle, or by another method conventionally used in plastics technology. The resulting savage shapes can be processed further to shaped articles, for example by injection molding. Finally, the preparations can also be obtained by compressing the components.

Films composed of the graft polymers to be used in accordance with the invention can be prepared by customary methods, for example by extruding or by casting. The film thickness is usually 10 to 1000 μm, preferably 30 to 500 μm and especially preferably 40 to 100 μm. The films can be used for manufacturing bags or pouches with which can be welded together, sealed together or glued together and which act as packaging for the agrochemical active ingredient formulations, but the latter can also be welded directly into film portions of a suitable size. Upon contact with water, the film disintegrates while releasing the active ingredient.

Agrochemicals which are present in the preparations according to the invention can take the form of seed, fertilizers and crop protection agents, in particular herbicidal, fungicidal, insecticidal, acaricidal and growth-regulatory agents.

Examples of suitable crop protection agents which may be mentioned hereinbelow are:

herbicides:

1,3,4-thiadiazoles, such as buthidazole, cyprazole;

amides such as allidochlor (CDAA), benzoylpropethyl, bromobutide, chlorthiamid, dimepiperate, dimethenamid, diphenamid, etobenzanid (benzchlomet), flamprop-methyl, fosamin, isoxaben, monalide;

naptalams, such as pronamide (propyzamide), propanil;

aminophosphoric acids such as bilanafos, (bialaphos), buminafos, glufosinate-ammonium, glyphosate, sulfosate;

aminotriazoles such as amitrol;

anilides such as anilofos, mefenacet;

aryloxyalkanoic acids such as 2,4-D, 2,4-DB, clomeprop, dichlorprop, dichlorprop-P, dichlorprop-P (2,4-DP-P), fenoprop (2,4,5-TP), fluoroxypyr, MCPA, MCPB, mecoprop, mecoprop-P, napropamide, napropanilide, triclopyr;

benzoic acids such as chloramben, dicamba;

benzothiadiazinones, such as bentazone;

bleachers such as clomazone (dimethazone), diflufenican, fluorochloridone, flupoxam, fluridone, pyrazolate, sulcotrione(chloromesulone);

carbamates such as asulam, barban, butylate, carbetamide, chlorbufam, chlorpropham, cycloate, desmedipham, di-allate, EPTC, esprocarb, molinate, orbencarb, pebulate, phenisopham, phenmedipham, propham, prosulfocarb, pyributicarb, sulf-allate (CDEC), terbucarb, thiobencarb (benthiocarb), thiocarbazil, tri-allate, vernolate;

quinolinecarboxylic acids such as quinclorac, quinmerac;

chloracetanilide such as acetochlor, alachlor, butachlor, butenachlor, diethatyl-ethyl, dimethachlor, metazachlor, metolachlor, pretilachlor, propachlor, prynachlor, terbuchlor, thenylchlor, xylachlor;

cyclohexenones such as alloxydim, caloxydim, clethodim, cloproxydim, cycloxydim, sethoxydim, tralkoxydim, 2-{1-[2-(4-chlorophenoxy)propyloxyimino]butyl}-3-hydroxy-5-(2H-tetrahydrothiopyran-3-yl)-2-cyclohexen-1-one;

dichloropropionic acids such as dalapon;

dihydrobenzofurans such as ethofumesate;

dihydrofuran-3-ones such as flurtamone;

dinitroanilines such as benefin, butralin, dinitramin, ethalfluralin, fluchloralin, isopropalin, nitralin, oryzalin, pendimethalin, prodiamine, profluralin, trifluralin;

dinitrophenols such as bromofenoxim, dinoseb, dinoseb-acetate, dinoterb, DNOC;

diphenyl ethers such as acifluorfen-sodium, aclonifen, bifenox, chlornitrofen (CNP), difenoxuron, ethoxyfen, fluorodifen, fluoroglycofen-ethyl, fomesafen, furyloxyfen, lactofen, nitrofen, nitrofluorfen, oxyfluorfen;

dipyridyls such as cyperquat, difenzoquat-methylsulfate, diquat, paraquat-dichloride;

ureas such as benzthiazuron, buturon, chlorbromuron, chloroxuron, chlortoluron, cumyluron, dibenzyluron, cycluron, dimefuron, diuron, dymron, ethidimuron, fenuron, fluormeturon, isoproturon, isouron, karbutilate, linuron, methabenzthiazuron, metobenzuron, metoxuron, monolinuron, monuron, neburon, siduron, tebuthiuron, trimeturon;

imidazoles such as isocarbamide;

imidazolinones such as imazamethapyr, imazapyr, imazaquin, imazethabenz-methyl (imazame), imazethapyr;

oxadiazoles such as methazole, oxadiargyl, oxadiazon;

oxiranes such as tridiphane;

phenols such as bromoxynil, ioxynil;

phenoxyphenoxypropionic esters such as clodinafop, cyhalofop-butyl, ciclofop-methyl, fenoxaprop-ethyl, fenoxaprop-p-ethyl, fenthiapropethyl, fluazifop-butyl, fluazifop-p-butyl, haloxyfop-ethoxyethyl,-haloxyfop-methyl, haloxyfop-p-methyl, isoxapyrifop, propaquizafop, quizalofop-ethyl, quizalofop-p-ethyl, quizalofop-tefuryl;

phenylacetic acids such as chlorfenac (fenac);

phenylpropionic acids such as chlorfenprop-methyl;

protoporphyrinogen-IX-oxidase inhibitors such as benzofenap, cinidon-ethyl, flumiclorac-pentyl, flumioxazin, flumipropyn, flupropacil, fluthiacet-methyl, pyrazoxyfen, sulfentrazone, thidiazimin;

pyrazoles such as nipyraclofen;

pyridazines such as chloridazon, maleic hydrazide, norflurazon, pyridate;

pyridinecarboxylic acids such as clopyralid, dithiopyr, picloram, thiazopyr;

pyrimidyl ethers such as pyrithiobac-acid, pyrithiobac-sodium, KIH-2023, KIH-6127;

sulfonamides such as flumetsulam, metosulam;

sulfonylureas such as amidosulfuron, azimsulfuron, bensulfuronmethyl, chlorimuron-ethyl, chlorsulfuron, cinosulfuron, cyclosulfamuron, ethametsulfuron methyl, ethoxysulfuron, flazasulfuron, halosulfuron-methyl, imazosulfuron, metsulfuron-methyl, nicosulfuron,-primisulfuron, prosulfuron, pyrazosulfuron-ethyl, rimsulfuron, sulfometuron-methyl, thifensulfuron-methyl, triasulfuron, tribenuron-methyl, triflusulfuron-methyl;

triazines such as ametryn, atrazine, aziprotryn, cyanazine, cyprazine, desmetryn, dimethamethryn, dipropetryn, eglinazine-ethyl, hexazinon, procyazine, prometon, prometryn, propazine, secbumeton, simazine, simetryn, terbumeton, terbutryn, terbutylazine, trietazine;

triazinones such as ethiozin, metamitron, metribuzin;

triazolecarboxamides such as triazofenamid;

uracils such as bromacil, lenacil, terbacil;

benazolin, benfuresate, bensulide, benzofluor, butamifos, cafenstrole, chlorthal-dimethyl (DCPA), cinmethylin, dichlobenil, endothall, fluorbentranil, mefluidide, perfluidone, piperophos;

growth regulators:

1-naphthylacetamide, 1-naphthylacetic acid, 2-naphthyloxyacetic acid, 3-CPA, 4-CPA, ancymidol, anthraquinone, BAP, butifos; tribufos, butralin, chlorflurenol, chlormequat, clofencet, cyclanilide, daminozide, dicamba, dikegulac-sodium, dimethipin, chlorfenethol, etacelasil, ethephon, ethychlozate, fenoprop, 2,4,5-TP, fluoridamid, flurprimidol, flutriafol, gibberellic acid, gibberellin, guazatine, imazalil, indolebutyric acid, indoleacetic acid, karetazan, kinetin, lactidichlor-ethyl, maleic hydrazide, mefluidide, mepiquat-chloride, naptalam, paclobutrazole, prohexadione-calcium, quinmerac, sintofen, tetcyclacis, thidiazuron, triiodobenzoic acid, triapenthenol, triazethan, tribufos, trinexapacethyl, uniconazole;

fungicides:

sulfur, dithiocarbamates and their derivatives such as iron(III) dimethyldithiocarbamate, zinc dimethyldithiocarbamate, zinc ethylenebisdithiocarbamate, manganese ethylenebisdithiocarbamate, manganese zinc ethylenediaminebisdithiocarbamate, tetramethylthiuram disulfide, ammonia complex of zinc (N,N-ethylenebisdithiocarbamate), ammonia complex of zinc (N,N′-propylenebisdithiocarbamate), zinc (N,N′-propylenebisdithiocarbamate), N,N′-polypropylenebis(thiocarbamoyl)disulfide;

nitro derivatives such as dinitro(l-methylheptyl)phenyl crotonate, 2-sec-butyl-4,6-dinitrophenyl 3,3-dimethylacrylate, 2-sec-butyl-4,6-dinitrophenylisopropyl carbonate, diisopropyl 5-nitro-isophthalate;

heterocyclic substances such as 2-heptadecyl-2-imidazoline acetate, 2,4-dichloro-6-(o-chloroanilino)-s-triazine, O,O-diethyl phthalimidophosphonothioate, 5-amino-1-[bis(dimethylamino)phosphinyl]-3-phenyl-1,2,4-triazole, 2,3-dicyano-1,4-dithioanthraquinone, 2-thio-1,3-dithiolo[4,5-b]-quinoxaline, methyl 1-(butylcarbamoyl)-2-benzimidazolecarbamate, 2-methoxycarbonylaminobenzimidazole, 2-(2-furyl)-benzimidazole, 2-(4-thiazolyl)benzimidazole, N-(1,1,2,2-tetrachloroethylthio)tetrahydrophthalimide, N-tri-chloromethylthiotetrahydrophthalimide, N-trichloromethylthiophthalimide, N-dichlorofluoromethylthio-N′,N′-dimethyl-N-phenylsulfodiamide, 5-ethoxy-3-trichloromethyl-1,2,3-thiadiazole, 2-thiocyanatomethylthiobenzothiazole, 1,4-dichloro-2,5-dimethoxybenzene, 4-(2-chlorophenylhydrazono)-3-methyl-5-isoxazolone, pyridine-2-thiol 1-oxide, 8-hydroxyquinoline or its copper salt, 2,3-dihydro-5-carboxanilido-6-methyl-1,4-oxathiine, 2,3-dihydro-5-carboxanilido-6-methyl-1,4-oxathiine 4,4-dioxide, 2-methyl-5,6-dihydro-4H-pyran-3-carboxanilide, 2-methylfuran-3-carboxanilide, 2,5-dimethylfuran-3-carboxanilide, 2,4,5-trimethylfuran-3-carboxanilide, 2,5-dimethylfuran-3-carboxanilide, N-cyclohexyl-N-methoxy-2,5-dimethylfuran-3-carboxamide, 2-methylbenzanilide, 2-iodobenzanilide, N-formyl-N-morpholine-2,2,2-trichloroethyl acetal, piperazine-1,4-diylbis-1-(2,2,2-trichloroethyl)formamide, 1-(3,4-dichloroanilino)-1-formylamino-2,2,2-trichloroethane, 2,6-dimethyl-N-tridecylmorpholine or its salts, 2,6-dimethyl-N-cyclododecylmorpholine or its salts, N-[3-(p-tert-butylphenyl)-2-methylpropyl]-cis-2,6-dimethylmorpholine, N-[3-(p-tert-butylphenyl)-2-methylpropyl]piperidine, 1-[2-(2,4-dichlorophenyl)-4-ethyl-1,3-dioxolan-2-yl-ethyl]-1H-1,2,4-triazole, 1-[2-(2,4-dichlorophenyl)-4-n-propyl-1,3-dioxolan-2-yl-ethyl]-1H-1,2,4-triazole, N-(n-propyl)-N-(2,4,6-trichlorophenoxyethyl)-N′-imidazolylurea, 1-(4-chlorophenoxy)-3,3-dimethyl-1-(1H-1,2,4-triazol-1-yl)-2-butanone, 1-(4-chlorophenoxy)-3,3-dimethyl-1-(1H-1,2,4-triazol-1-yl)-2-butanol, (2RS,3RS)-1-[3-(2-chlorophenyl)-2-(4-fluorophenyl)oxiran-2-ylmethyl]-1H-1,2,4-triazole, α-(2-chlorophenyl)-α-(4-chlorophenyl)-5-pyrimidinemethanol, 5-butyl-2-dimethylamino-4-hydroxy-6-methylpyrimidine, bis(p-chlorophenyl)-3-pyridinemethanol, 1,2-bis(3-ethoxycarbonyl-2-thioureido)benzene, 1,2-bis(3-methoxycarbonyl-2-thioureido)benzene;

anilinopyrimidines such as N-(4,6-dimethylpyrimidin-2-yl)aniline, N-[4-methyl-6-(1-propynyl)pyrimidin-2-yl]aniline, N-[4-methyl-6-cyclopropylpyrimidin-2-yl]aniline;

phenylpyrroles such as 4-(2,2-difluoro-1,3-benzodioxol-4-yl)pyrrole-3-carbonitrile;

cinnamamides such as 3-(4-chlorophenyl)-3-(3,4-dimethoxy-phenyl)acryloylmorpholine;

dodecylguanidine acetate, 3-[3-(3,5-dimethyl-2-oxycyclohexyl)-2-hydroxyethyl]glutarimide, hexachlorobenzene, methyl N-(2,6-dimethylphenyl)-N-(2-furoyl)-DL-alaninate, DL-N-(2,6-dimethylphenyl)-N-(2′-methoxyacetyl)-alanine methyl ester, N-(2,6-dimethylphenyl)-N-chloroacetyl-D,L-2-aminobutyrolactone, DL-N-(2,6-dimethylphenyl)-N-(phenylacetyl)alanine methyl ester, 5-methyl-5-vinyl-3-(3,5-dichlorophenyl)-2,4-dioxo-1,3-oxazolidine, 3-[3,5-dichlorophenyl(5-methyl-5-methoxymethyl]-1,3-oxazolidine-2,4-dione, 3-(3,5-dichlorophenyl)-1-isopropylcarbamoylhydantoin,

N-(3,5-dichlorophenyl)-1,2-dimethylcyclopropane-1,2-dicarboximide, 2-cyano-[N-(ethylaminocarbonyl)-2-methoximino]acetamide, 1-[2-(2,4-dichlorophenyl)pentyl]-1H-1,2,4-triazole, 2,4′-difluoro-α-(1H-1,2,4-triazolyl-1-methyl)benzhydryl alcohol, N-(3-chloro-2,6-dinitro-4-trifluoromethylphenyl)-5-trifluoromethyl-3-chloro-2-aminopyridine, 1-((bis-(4-fluorophenyl)methylsilyl)methyl)-1H-1,2,4-triazole,

strobilurins of the formula II

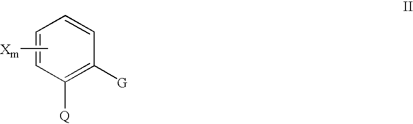

in which the variables have the following meanings:

X is halogen, C₁-C₄-alkyl or trifluoromethyl;

m is 0 or 1;

Q is C(═CH—CH₃)—COOCH₃, C(═CH—OCH₃)—COOCH₃, C(═N—OCH₃)—CONHCH₃, C(═N—OCH₃)—COOCH₃ or N(—OCH₃)—COOCH₃;

G is —O-L, —CH₂O-L, —OCH₂-L, —CH═CH-L, —C≡C-L, —CH₂O—N═C(R¹¹)-L or —CH₂O—N═C(R¹¹)—C(R¹²)═N—OR¹³;

B is phenyl, naphthyl, 5-membered or 6-membered hetaryl or 5-membered or 6-membered heterocyclyl, comprising one to three N-atoms and/or one O or S atom or one or two O and/or S atoms, the ring systems being unsubstituted or substituted by one to three radicals R^{a};

R^{a} is cyano, nitro, amino, aminocarbonyl, aminothiocarbonyl, halogen, C₁-C₆-alkyl, C₁-C₆-haloalkyl, C₁-C₆-alkylcarbonyl, C₁-C₆-alkylsulfonyl, C₁-C₆-alkylsulfoxyl, C₃-C₆-cycloalkyl, C₁-C₆-alkoxy, C₁-C₆-haloalkoxy, C₁-C₆-alkyloxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, phenyl, phenoxy, benzyl, benzyloxy, 5- or 6-membered heterocyclyl, 5- or 6-membered hetaryl, 5- or 6-membered hetaryloxy, C(═NOR⁶⁰ )—OR⁶² or OC(R⁶⁰ )₂—C(R^{β})═NOR^{β} the cyclic radicals, in turn, being unsubstituted or substituted by one to three radicals R^{b};

R^{b} is cyano, nitro, halogen, amino, aminocarbonyl, aminothiocarbonyl, C₁-C₆-alkyl, C₁-C₆-haloalkyl, C₁-C₆-alkylsulfonyl, C₁-C₆-alkylsulfoxyl, C₃-C₆-cycloalkyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, C₃-C₆-cycloalkyl, C₃-C₆-cycloalkenyl, phenyl, phenoxy, phenylthio, benzyl, benzyloxy, 5- or 6-membered heterocyclyl, 5- or 6-membered hetaryl, 5- or 6-membered hetaryloxy or C(═NOR^{α})—OR^{β};

R^{α}, R^{β} are hydrogen or C₁-C₆-alkyl;

R¹¹ is hydrogen, cyano, C₁-C₄-alkyl, C₁-C₄-haloalkyl, C₃-C₆-cycloalkyl, C₁-C₄-alkoxy;

R¹² is phenyl, phenylcarbonyl, phenylsulfonyl, 5- or 6-membered hetaryl, 5- or 6-membered hetarylcarbonyl or 5- or 6-membered hetarylsulfonyl, the ring systems being unsubstituted or substituted by one to three radicals R^{a},

C₁-C₁₀-alkyl, C₃-C₆-cycloalkyl, C₂-C₁₀-alkenyl, C₂-C₁₀-alkynyl, C₁-C₁₀-alkylcarbonyl, C₂-C₁₀-alkenylcarbonyl, C₃-C₁₀-alkynylcarbonyl, C₁-C₁₀-alkylsulfonyl, or C(═NOR^{α})—R^{β}, the hydrocarbon radicals of these groups being unsubstituted or substituted by one to three radicals R^{c};

R^{c} is cyano, nitro, amino, aminocarbonyl, aminothiocarbonyl, halogen, C₁-C₆-alkyl, C₁-C6-haloalkyl, Cₗ-C₆-alkylsulfonyl, C₁-C₆-alkylsulfoxyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy,

C₃-C₆-cycloalkyl, C₃-C₆-cycloalkyloxy, 5- or 6-membered heterocyclyl, 5- or 6-membered heterocyclyloxy, benzyl, benzyloxy, phenyl, phenoxy, phenylthio, 5- or 6-membered hetaryl, 5- or 6-membered hetaryloxy and hetarylthio, it being possible for the cyclic groups, in turn, to be partially or fully halogenated or to have attached to them one to three radicals R^{a};

R¹³ is hydrogen; C₁-C₆-alkyl, C₂-C₆-alkenyl, C₂-₆-alkynyl, the hydrocarbon radicals of theses groups being unsubstituted or substituted by one to three radicals R^{c}.

Examples of individual strobilurins which may be mentioned are the following:

TABLE I

| | |
|---|---|
| | III |
| 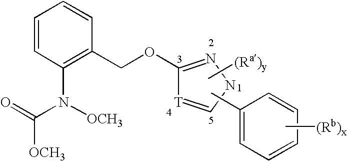 | |

| | | | Position of the | | |
|---|---|---|---|---|---|
| No. | T | (R^{a′})_{y} | group phenyl-(R^{b})ₓ | (R^{b})ₓ | Literature |
| I-1 | N | — | 1 | 2,4-Cl₂ | WO-A 96/01256 |
| I-2 | N | — | 1 | 4-Cl | WO-A 96/01256 |
| I-3 | CH | — | 1 | 2-Cl | WO-A 96/01256 |
| I-4 | CH | — | 1 | 3-Cl | WO-A 96/01256 |
| I-5 | CH | — | 1 | 4-Cl | WO-A 96/01256 |
| I-6 | CH | — | 1 | 4-CH₃ | WO-A 96/01256 |
| I-7 | CH | — | 1 | H | WO-A 96/01256 |
| I-8 | CH | — | 1 | 3-CH₃ | WO-A 96/01256 |
| I-9 | CH | 5-CH₃ | 1 | 3-CF₃ | WO-A 96/01256 |
| I-10 | CH | 1-CH₃ | 5 | 3-CF₃ | WO-A 99/33812 |
| I-11 | CH | 1-CH₃ | 5 | 4-Cl | WO-A 99/33812 |
| I-12 | CH | 1-CH₃ | 5 | — | WO-A 99/33812 |

TABLE II

| | |
|---|---|
| | IV |
| 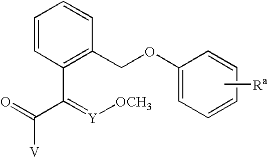 | |

| No. | V | Y | R^{a} | Literature |
|---|---|---|---|---|
| II-1 | OCH₃ | N | 2-CH₃ | EP-A 253 213 |
| II-2 | OCH₃ | N | 2,5-(CH₃)₂ | EP-A 253 213 |
| II-3 | NHCH₃ | N | 2,5-(CH₃)₂ | EP-A 398 692 |
| II-4 | NHCH₃ | N | 2-Cl | EP-A 398 692 |
| II-5 | NHCH₃ | N | 2-CH₃ | EP-A 398 692 |
| II-6 | NHCH₃ | N | 2-CH₃, 4-OCF₃ | EP-A 628 540 |
| II-7 | NHCH₃ | N | 2-Cl, 4-OCF₃ | EP-A 628 540 |
| II-8 | NHCH₃ | N | 2-CH₃,4-OCH(CH₃)—C(CH₃)═NOCH₃ | DE Appl. 10002661.3 |
| II-9 | NHCH₃ | N | 2-Cl, 4-OCH(CH₃)—C(CH₃)═NOCH₃ | DE Appl. 10002661.3 |
| II-10 | NHCH₃ | N | 2-CH₃, 4-OCH(CH₃)—C(CH₂CH₃)═NOCH₃ | DE Appl. 10002661.3 |
| II-11 | NHCH₃ | N | 2-Cl, 4-OCH(CH₃)—C(CH₃)═NOCH₂CH₃ | DE Appl. 10002661.3 |

TABLE III

| | |
|---|---|
| | V |
| 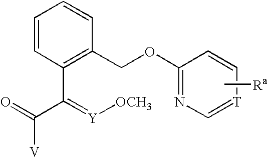 | |

| No. | V | Y | T | R^{a} | Literature |
|---|---|---|---|---|---|
| III-1 | OCH₃ | CH | N | 2-OCH₃, 6-CF₃ | WO-A 96/16047 |
| III-2 | OCH₃ | CH | N | 2-OCH(CH₃)2, 6-CF₃ | WO-A 96/16047 |
| III-3 | OCH₃ | CH | CH | 5-CF₃ | EP-A 278 595 |
| III-4 | OCH₃ | CH | CH | 6-CF₃ | EP-A 278 595 |
| III-5 | NHCH₃ | N | CH | 3-Cl | EP-A 398 692 |
| III-6 | NHCH₃ | N | CH | 3-CF₃ | EP-A 398 692 |
| III-7 | NHCH₃ | N | CH | 3-CF₃, 5-Cl | EP-A 398 692 |
| III-8 | NHCH₃ | N | CH | 3-Cl, 5-CF₃ | EP-A 398 692 |

TABLE IV

| | |
|---|---|
| | VI |
| 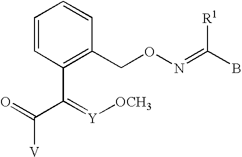 | |

| No. | V | Y | R¹ | B | Literature |
|---|---|---|---|---|---|
| IV-1 | OCH₃ | CH | CH₃ | (3-CF₃)C₆H₄ | EP-A 370 629 |
| IV-2 | OCH₃ | CH | CH₃ | (3,5-Cl₂)C₆H₃ | EP-A 370 629 |
| IV-3 | NHCH₃ | N | CH₃ | (3-CF₃)C₆H₄ | WO-A92/13830 |
| IV-4 | NHCH₃ | N | CH₃ | (3-OCF₃)C₆H₄ | WO-A92/13830 |
| IV-5 | OCH₃ | N | CH₃ | (3-OCF₃)C₆H₄ | EP-A 460 575 |
| IV-6 | OCH₃ | N | CH₃ | (3-CF₃)C₆H₄ | EP-A 460 575 |
| IV-7 | OCH₃ | N | CH₃ | (3,4-Cl₂)C₆H₃ | EP-A 460 575 |
| IV-8 | OCH₃ | N | CH₃ | (3,5-Cl₂)C₆H₃ | EP-A 463 488 |

TABLE V

| | |
|---|---|
| | VII |
| 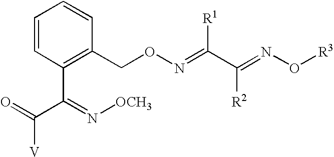 | |

| No. | V | R¹ | R² | R³ | Literature |
|---|---|---|---|---|---|
| V-1 | OCH₃ | CH₃ | CH₃ | CH₃ | WO-A 95/18789 |
| V-2 | OCH₃ | CH₃ | CH(CH₃)₂ | CH₃ | WO-A 95/18789 |
| V-3 | OCH₃ | CH₃ | CH2CH₃ | CH₃ | WO-A 95/18789 |
| V-4 | NHCH₃ | CH₃ | CH₃ | CH₃ | WO-A 95/18789 |
| V-5 | NHCH₃ | CH₃ | 4-F-C₆H₄ | CH₃ | WO-A 95/18789 |
| V-6 | NHCH₃ | CH₃ | 4-Cl-C₆H₄ | CH₃ | WO-A 95/18789 |
| V-7 | NHCH₃ | CH₃ | 2,4-C₆H₃ | CH₃ | WO-A 95/18789 |
| V-8 | NHCH₃ | Cl | 4-F-C₆H₄ | CH₃ | WO-A 98/38857 |
| V-9 | NHCH₃ | Cl | 4-Cl-C₆M₄ | CH₂CH₃ | WO-A 98/38857 |
| V-10 | NHCH₃ | CH₃ | CH₂C(═CH₂)CH₃ | CH₃ | WO-A 97/05103 |
| V-11 | NHCH₃ | CH₃ | CH═C(CH₃)₂ | CH₃ | WO-A 97/05103 |
| V-12 | NHCH₃ | CH₃ | CH═C(CH₃)₂ | CH₂CH₃ | WO-A 97/05103 |
| V-13 | NHCH₃ | CH₃ | CH═C(CH₃)CH₂CH₃ | CH₃ | WO-A 97/05103 |
| V-14 | NHCH₃ | CH₃ | O—CH(CH₃)₂ | CH₃ | WO-A 97/06133 |
| V-15 | NHCH₃ | CH₃ | O—CH₂CH(CH₃)₂ | CH₃ | WO-A 97/06133 |
| V-16 | NHCH₃ | CH₃ | C(CH₃)═NOCH₃ | CH₃ | WO-A 97/15552 |

TABLE VI

| | |
|---|---|
| | VIII |
| 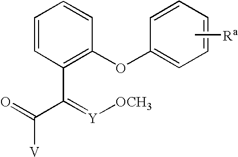 | |

| No. | V | Y | R^{a} | Literature |
|---|---|---|---|---|
| VI-1 | NHCH₃ | N | H | EP-A 398 692 |
| VI-2 | NHCH₃ | N | 3-CH₃ | EP-A 398 692 |
| VI-3 | NHCH₃ | N | 2-NO₂ | EP-A 398 692 |
| VI-4 | NHCH₃ | N | 4-NO₂ | EP-A 398 692 |
| VI-5 | NHCH₃ | N | 4-Cl | EP-A 398 692 |
| VI-6 | NHCH₃ | N | 4-Br | EP-A 398 692 |

TABLE VII

| | |
|---|---|
| | IX |
| 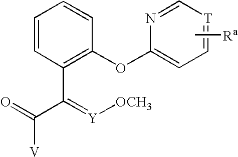 | |

| No. | V | Y | T | R^{a} | Literature |
|---|---|---|---|---|---|
| VII-1 | OCF₃ | CH | N | 6-O-(2-CH—C₆H₄) | EP-A 382 375 |
| VII-2 | OCH₃ | CH | N | 6-O-(2-Cl—C₆H₄) | EP-A 382 375 |
| VII-3 | OCH₃ | CH | N | 6-O-(2-CH₃—C₆H₄) | EP-A 382 375 |
| VII-4 | NHCH₃ | N | N | 6-O-(2-Cl—C₆H₄) | GB-A 2253624 |
| VII-5 | NHCH₃ | N | N | 6-O-(2,4-Cl₂—C₆H₃) | GB-A 2253624 |
| VII-6 | NHCH₃ | N | N | 6-O-(2-CH₃—C₆H₄₎ | GB-A 2253624 |
| VII-7 | NHCH₃ | N | N | 6-O-(2-CH₃,3-Cl—C₆H₃) | GB-A 2253624 |
| VII-8 | NHCH₃ | N | N | 2-F, 6-O-(2-CH₃—C₆H₄₎ | WO-A 98/21189 |
| VII-9 | NHCH₃ | N | N | 2-F, 6-O-(2-Cl—C₆H₄₎ | WO-A 98/21189 |
| VII-10 | NHCH₃ | N | N | 2-F, | WO-A 98/21189 |
| | | | | 6-O-(2-CH₃,3-Cl—C₆H₃) | |

Especially preferred examples which may be mentioned are methyl E-methoxyimino-[α-(o-tolyloxy)-o-tolyl]acetate, methyl E-2-{2-[6-(2-cyanophenoxy)-pyrimidin-4-yloxy]-phenyl}-3-methoxy-acrylate, methyl E-methoxyimino-[α-(2-phenoxyphenyl)]acetamide, methyl E-methoxyimino-[α-(2,5-dimethylphenoxy)-o-tolyl]-acetamide, methyl N-[[[1-(4-chlorophenyl)pyrazol-3-yl]oxy]-o-tolyl]-N-methoxycarbamate and N-methyl-2-(methoxyimino)-2-{2-[(3E,6E)-5-(methoxyimino)-4,6-dimethyl-2,8-dioxa-3,7-diazanona-3,6-dien-1-yl]phenyl}acetamide.

The strobilurins can be employed together with further active ingredients against pests (for example insects, arachnids or nematodes) and/or harmful fungi, together with herbicidal and/or growth-regulating active ingredients and/or fertilizers.

They are of particular importance for controlling a large number of fungi on a variety of crop plants such as cotton, vegetable plants (for example cucumbers, beans and cucurbits), barley, grass, oats, coffee, maize, fruit plants, rice, rye, soybean, grapevine, wheat; ornamentals, sugar cane and a variety of seeds.

Speficially, they are suitable for controlling in particular the following plant diseases:

Alternaria species in vegetables and fruit,

Botrytis cinerea (gray mold) in strawberries, vegetables, ornamentals and grapevines,

Cercospora arachidicola in peanuts,

Erysiphe cichoracearum and Sphaerotheca fuliginea in cucurbits,

Erysiphe graminis (powdery mildew) in cereals,

Fusarium and Verticillium species in a variety of plants,

Helminthosporium species in cereals,

Mycosphaerella species in bananas,

Phytophthora infestans in potatoes and tomatoes,

Plasmopara viticola in grapevines,

Podosphaera leucotricha in apples,

Pseudocercosporella herpotrichoides in wheat and barley,

Pseudocercosporella species in hops and cucumbers,

Pseudoperonospora species in hops and cucumbers,

Puccinia species in cereals,

Pyricularia oryzae in rice,

Rhizoctonia species in cotton, rice and lawns,

Septoria nodorum in wheat,

Uncinula necator in grapevines,

Ustilago species in cereals and sugarcane,

Venturia inaequalis (scab) in apples.

### EXAMPLES

Preparation of the Graft Polymer P1

In a polymerization vessel, 72 g of polyethylene glycol (average molecular weight 6000, Pluriol® E 6000, BASF) were heated to 80° C. with stirring and while passing in a gentle stream of nitrogen.

410 g of vinyl acetate and, in parallel, a solution of 1.4 g of tert-butyl perpivalate in 30 g of methanol were added dropwise in the course of 3 hours while maintaining this temperature, with continued stirring. After the addition was complete, stirring was continued for 2 hours at 80° C.

After cooling, the graft polymer was dissolved in 450 ml of methanol. For hydrolysis, 50 ml of a 10% strength methanolic sodium hydroxide solution were added at 30° C. After approximately 40 minutes, the reaction was quenched by adding 750 ml of 1% by weight strength acetic acid. The solution was subjected to steam distillation in order to remove the methanol.

Subsequent freeze-drying of the clear solution gave a white powder. A 20% by weight strength aqueous solution of the resulting graft polymer had a viscosity of 124 mPas. The graft polymer had a K value of 54 and the elongation at break was 74%.

### Example 1

Use of the graft polymer P1 as matrix former for agrochemical preparations with controlled release of active ingredient

Graft polymer P1, fungicide F1(compound V-16 of Table V), polybutylene adipate terephthalate (Ecoflex®, BASF) as water-insoluble polymeric binder and calcium carbonate (Merck) as filler were mixed in the quantitative ratios which can be seen in each case from Table VIII (data in % by weight based on the total preparation) and, via a weigh feeder, introduced into the conveying zone (zone 0) of a closely conformationed counter-rotating twin-screw extruder (Haake Rheocord 90 equipped with mixing screw and 2 mm nozzle, Haake) and homogenized over 10 temperature zones (80, 120, 153, 154, 154, 153, 153, 152, 152, 140° C.) at a throughput of 1 kg/h and a screw speed of 200 rpm, plastified, and, at the extruder head discharged onto a metal conveyor belt layer via a 2 mm nozzle. The extrudate was then introduced into a strand granulator, diameter 1.1 mm (SGS 100/E, C. F. Scheer & CIE) via an air chute and a conveying drum (Haake TP1), and formulated into cylindrical granules with an average cross-section of 1.0-1.2 mm.

TABLE VIII

| Preparation | P1 | Ecoflex ® | F1 | CaCO₃ |
|---|---|---|---|---|
| A | 4.98 | 37.89 | 7.0 | 49.83 |
| B | 9.97 | 32.89 | 7.0 | 49.83 |
| C | 14.95 | 27.90 | 7.0 | 49.83 |
| D | 19.93 | 22.92 | 7.0 | 49.83 |
| E | 42.83 | — | 7.0 | 49.83 |

To determine the release of active ingredient, in each case 1 g of granules of the above preparations were covered, in a 1 l graduated flask, 1 l of drinking water. The graduated flask was stored at 25° C. under vibration-proof conditions. To determine the release of active ingredient, samples were taken daily. Prior to sampling, the graduated flask was turned by 180° and the content mixed in order to ensure a homogeneous distribution of the active ingredient. The samples taken were subsequently measured at 250 nm using a UV/VIS spectroscope (HP 8452, Diode Array Spectrophotometer, 1 cm quartz chamber, Hewlett-Packard) and returned to the flask. Calibration curves (absorption plotted versus concentration) of the active ingredients have been established beforehand.

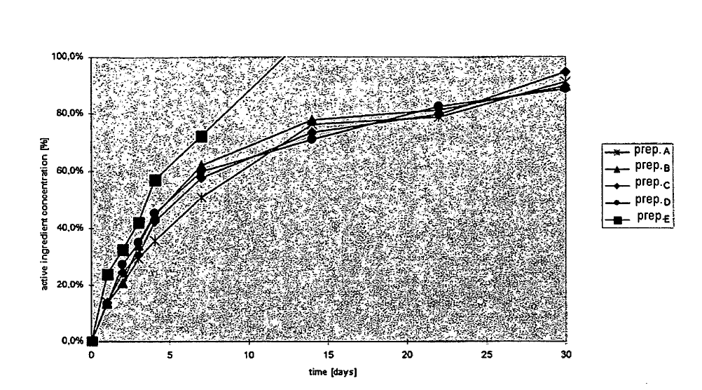

The release curves of preparations A to E are shown in FIG. 1. The percentage release was plotted in each case versus the time in days (100% means the complete release of 50 ppm of active ingredient for 1 g of 5% by weight strength preparation in 1 l of water).

The cumulative release of the active ingredient was in each case square-root-dependent, as was expected for a diffusion process (t√ law):

c=K√t

c: active ingredient concentration; t: time

Moreover, it was shown that the release of active ingredient was greatly dependent on the composition of the polymer matrix. The release of active ingredient can be controlled specifically by varying the amount of graft polymer, additional polymeric binder and filler.

Example 2

Use of the graft polymer P1 as matrix former and dispersant for agrochemical preparations with water-insoluble active ingredient

Graft polymer P1, fungicide F2 (compound I-2 of Table I, Pyraclostrubin, BASF), polyvinylpyrrolidone (Luviskol® K30, BASF) as binder (PVP), sodium diisobutylnaphthalenate (Wettol® NT1, BASF), polyethylene oxide/polypropylene oxide block copolymer (Pluriol® 8000, BASF) and sodium dodecylbenzenesulfonate

(Aldrich, DBSN) as surface-active additives were mixed in each case in the quantitative ratios which can be seen from Table IX (data in % by weight based on the total preparation) and extruded in a Rheomix 600 twin-screw kneader equipped with sensor (Haake) at 160° C. After cooling, the mixtures were ground to give powders of particle sizes of 100-250 μm.

To determine the dispersibility, in each case 1 g of the pulverulent preparation were introduced, with stirring (Ikamag RET-G magnetic stirrer, Jahnke & Kunkel), into a 1 l storage flask containing 1 l of tap water (20° C.) at a stirring speed of 300 rpm. The dissolution, or disintegration, of the powder and thus the release of the active ingredient was monitored visually; Table IX shows the time to dissolution.

TABLE IX

| | | | | | | | Dis- |
|---|---|---|---|---|---|---|---|
| Prep- | | | | Wettol ® | Pluriol ® | | solution |
| aration | P1 | PVP | F2 | NT1 | 8000 | DBSN | (min) |
| F | 55 | 40 | — | 5 | — | — | 60 |
| G | 55 | 40 | — | — | 5 | — | 60 |
| H | 55 | 40 | — | — | — | 5 | 60 |
| I | 27.5 | 40 | 27.5 | 5 | — | — | 45 |

### Example 3

Use of the graft polymer 1 for manufacturing water-soluble film bags for agrochemical formulations

The graft polymer 1 was cast into a film (I) having a thickness of 40 μm and a film (II) having a thickness of 100 μm. 20 g of a commercially available crop protection formulation were welded into each film using a customary household film welder.

The film bags (I) and (II) filled thus were each placed into a glass beaker filled with water (20° C).

The time required for the film bags to dissolve without residue was 20 seconds in the case of film bag (I) and 60 seconds in the case of film bag (II).

### Example 4

Use of the graft polymer P1 as coating composition for agrochemical preparations in tablet form

Firstly, a spray dispersion was prepared which was composed as follows:

| | |
|---|---|
| 10.0% by weight | of graft polymer P1 |
| 1.5% by weight | of iron oxide red (Sicovit ® rot, BASF) |
| 3.0% by weight | of titanium dioxide BN 56 (Kronos) |
| 4.5% by weight | of talcum powder (Riedel de Haen) |
| 81.0% by weight | of water |

this was done by dissolving the graft polymer P1 in water and adding Sicovit rot, titanium dioxide and talcum. The dispersion was then homogenized by grinding in a corundum disc mill.

To produce a film coating, 1260 g (including 10% by weight extra to cover spray losses) of the resulting aqueous dispersion were then sprayed, in a horizontal drum coater (Accela-Cota 24″, Manesty) from a 1 mm wide spray nozzle at an air temperature of 60° C., a spray rate of 30 g/min and a spray pressure of 2 bar onto 5000 g of convex tablet cores with a thickness of 9 mm composed of 40 mg of the fungicide F2 (compound I-2 of Table I, pyraclostrubin, BASF), 195.0 mg of Ludipresse® (BASF), 12.5 mg of Kollidon® VA 64 (BASF) and 2.5 mg of magnesium stearate.

We claim:

1. The use of water-soluble or water-dispersible, film-forming graft polymers obtainable by free-radical polymerization of
(a) vinyl esters of aliphatic C₁-C₂₄-carboxylic acids in the presence of
(b) polyethers with an average molecular weight (number average) of at least 300 of the formula I
R¹—((R²—O)ᵤ(R³—O)ᵥ(R⁴—O)_{w}[A(R⁵—O)ₓ(R⁶—O)_{y}(R⁷—O)_{z}]ₛR⁸)ₙ I
in which the variables independently of one another have the following meanings:
R¹ is hydroxyl, amino, C₁-C₂₄-alkoxy, R⁹—COO—, R⁹—NH—COO—, polyalcohol residue;
R² to R⁷ are —(CH₂)₂—, —(CH₂)₃—, —(CH₂)₄—, —CH₂—CH(CH₃)—, —CH₂—CH(CH₂—CH₃)—, —CH₂—CHOR¹⁰—CH₂—;
R⁸ is hydrogen, amino-C₁-C₆-alkyl, C₁-C₂₄-alkyl, R⁹—CO—, R⁹—NH—CO—;
R⁹ is C₁-C₂₄-alkyl;
R¹⁰ is hydrogen, C₁-C₂₄-alkyl, R⁹—CO—;
A is —CO—O—, —CO—B—CO—O—, —CO—NH—B—NH—CO—O—;
B is —(CH₂)ₜ—, unsubstituted or substituted arylene;.
n is 1 or, if R¹ is a polyalcohol residue, 1 to 8;
s is 0 to 500;
t is 1 to 12;
v is 0 to 5000;
w is 0 to 5000;
x is 1 to 5000;
y is 0 to 5000;
z is 0 to 5000
as coating materials, matrix formers and/or packaging materials for agrochemicals.

2. The use as claimed in claim 1, wherein the graft polymers are obtainable by polymerization of
(a) vinyl acetate in the presence of
(b) polyalkylene oxides, polyalkylene oxides which are end-group-capped at one end and/or polyalkylene oxides which are end-group-capped at both ends.

3. The use as claimed in claim 1 or 2, wherein the graft polymers are obtainable by polymerization of
(a) vinyl acetate in the presence of
(b) polyethylene glycols with an average molecular weight (number average) of 500 to 100 000.

4. The use as claimed in any of claims 1 to 3, wherein 20 to 100 mol % of the vinyl ester units of the graft polymers have been hydrolyzed.

5. The use as claimed in any of claims 1 to 4, wherein the polymerization is carried out in the presence of 0.1 to 30% by weight of comonomers (c), based on the mixture of monomers (a) and comonomers (c).

6. The use as claimed in any of claims 1 to 5, wherein the agrochemicals are seed, fertilizers or crop protection products.

7. The use as claimed in any of claims 1 to 6, wherein the graft polymers are employed in finely divided form for coating agrochemical preparations.

8. The use as claimed in any of claims 1 to 6, wherein the graft polymers are employed as matrix formers in granular agrochemical preparations.

9. The use as claimed in any of claims 1 to 6, wherein the graft polymers are used in the form of films with a thickness of 10 to 1000 μm as packaging material for agrochemical active ingredient formulations.

10. An agrochemical preparation in tablet form exhibiting a formulation of one or more agrochemical active ingredients as the tablet core with a coating comprising one or more graft polymers as set forth in claims 1 to 5.

11. An agrochemical preparation in granule form exhibiting one or more agrochemical active ingredients in a matrix comprising one or more graft polymers as set forth in claims 1 to 5 as matrix former.

12. An agrochemical preparation in the form of a single portion for dosage purposes, where an agrochemical active ingredient formulation is packaged portionwise in films comprising one or more graft polymers as set forth in claims 1 to 5.
